(19) United States
(12) Patent Application Publication
(10) Pub. No.: US 2026/0292789 A1
(43) Pub. Date: Sep. 24, 2026

(54) METHOD PERFORMED BY USER EQUIPMENT, AND USER EQUIPMENT

(71) Applicant: Sharp Kabushiki Kaisha, Sakai City, Osaka (JP)

(72) Inventors: Yinan ZHAO, Shanghai (CN); Chao LUO, Shanghai (CN); Renmao LIU, Shanghai (CN)

(21) Appl. No.: 19/167,974

(22) PCT Filed: Mar. 28, 2024
(86) PCT No.: PCT/CN2024/084404

§ 371 Date: Sep. 23, 2025

(30) Foreign Application Priority Data
Mar. 29, 2023 (CN) 202310325745.4

(51) Int. Cl. H04W 72/02; H04W 72/0446; H04W 72/0453

(52) U.S. Cl. CPC H04W 72/02; H04W 72/0446; H04W 72/0453

(57) ABSTRACT

The present invention provides a method performed by a user equipment, and a user equipment. The method includes the following steps: selecting, by a sidelink user equipment, to generate one selected sidelink grant, the one selected sidelink grant corresponding to transmissions of one or more media access control layer (MAC) protocol data units (PDUs); and performing, by the user equipment, a transmission resource selection procedure.

### TECHNICAL FIELD

The present invention relates to the technical field of wireless communications, and in particular to a method performed by a user equipment, and a corresponding user equipment.

### BACKGROUND ART

In conventional cellular networks, all communication needs to pass through base stations. By contrast, D2D communication (device-to-device communication, device-to-device direct communication) refers to a direct communication method between two user equipment units without forwarding via a base station or a core network. A research project on the use of LTE devices to implement proximity D2D communication services was approved at the 3rd Generation Partnership Project (3GPP) RAN #63 plenary meeting in March 2014 (see Non-Patent Document 1). The functions introduced in the LTE Release 12 D2D include:
1) a discovery function between proximate devices in an LTE network coverage scenario;
2) a direct broadcast communication function between proximate devices; and
3) support for unicast and groupcast communication functions at higher layers.

A research project on enhanced LTE eD2D (enhanced D2D) was approved at the 3GPP RAN #66 plenary meeting in December 2014 (see Non-Patent Document 2). The main functions introduced in the LTE Release 13 eD2D include:
1) D2D discovery in out-of-coverage and partial-coverage scenarios; and
2) a priority handling mechanism for D2D communication.

Based on the design of the D2D communication mechanism, a V2X feasibility research project based on D2D communication was approved at the 3GPP RAN #68 plenary meeting in June 2015. V2X stands for Vehicle to Everything, and is used to implement information exchange between a vehicle and all entities that may affect the vehicle, for the purpose of reducing accidents, alleviating traffic congestion, reducing environmental pollution, and providing other information services. Application scenarios of V2X mainly include four aspects:
1) V2V, Vehicle to Vehicle, i.e., vehicle-to-vehicle communication;
2) V2P, Vehicle to Pedestrian, i.e., a vehicle transmits alarms to a pedestrian or a non-motorized vehicle;
3) V2N, Vehicle-to-Network, i.e., a vehicle connects to a mobile network;
4) V2I, Vehicle-to-Infrastructure, i.e., communication such as that between a vehicle and road infrastructure.

3GPP divides the research and standardization of V2X into three stages. The first stage was completed in September 2016, and mainly focused on V2V and was based on LTE Release 12 and Release 13 D2D (also known as sidelink), that is, the development of proximity communication technologies (see Non-Patent Document 3). V2X stage 1 introduced a new D2D communication interface referred to as a PC5 interface. The PC5 interface is mainly used to address the issue of cellular Internet of Vehicle (IoV) communication in high-speed (up to 250 km/h) and high-node-density environments. Vehicles can exchange information such as position, speed, and direction through the PC5 interface, that is, the vehicles can communicate directly through the PC5 interface. Compared with the proximity communication between D2D devices, the functions introduced in LTE Release 14 V2X mainly include:
1) higher density DMRS to support high-speed scenarios;
2) introduction of sub-channels to enhance resource allocation methods; and
3) introduction of a user equipment sensing mechanism having semi-persistent scheduling.

The second stage of the V2X research project belongs to the LTE Release 15 research category (see Non-Patent Document 4). The introduced main features include high-order 64QAM modulation, V2X carrier aggregation, and short TTI transmission, and also include feasibility study on transmit diversity.

The corresponding third stage, a V2X feasibility research project based on 5G NR network technologies (see Non-Patent Document 5), was approved at the 3GPP RAN #80 plenary meeting in June 2018.

In the 5G NR V2X project, user equipment sensing-based resource allocation mode 2, or referred to as transmission mode 2, is supported. For user equipment sensing-based resource allocation mode 2, a physical layer of the user equipment senses transmission resources in a resource pool, which indicates that the user equipment, according to indication information in received SCI transmitted by another user equipment, determines whether to exclude a resource that is in a candidate resource set and that overlaps with a resource indicated by the indication information, resources that are not excluded from the candidate resource set are reported to a higher layer, and the higher layer randomly selects resources from the reported resource set for PSSCH/PSCCH transmissions.

A standardization study project based on standardized NR sidelink enhancement (see Non-Patent Document 6) was approved at the 3GPP RAN #90e plenary meeting in December 2020. The sidelink enhancement includes the following three aspects:
1) Resource allocation modes for power consumption reduction (power saving) of sidelink user equipment are standardized, including but not being limited to: partial sensing-based resource allocation modes, and random resource selection-based resource allocation modes;
2) Research is conducted to improve the communication reliability of resource allocation mode 2 in NR sidelink and reduce communication latency of resource allocation mode 2;
3) Standardized sidelink (SL) discontinuous reception (abbreviated as SL DRX) mechanisms. In 5G NR communication, user equipment supports temporally discontinuous reception of a physical downlink control channel (PDCCH), referred to as DRX, thereby effectively reducing power consumption of communication devices. Similarly, corresponding to SL DRX, discontinuous reception refers to monitoring sidelink control information SCI (including 1st-stage SCI and 2nd-stage SCI) within a partial time in the time domain, and the time is referred to as active time.

A standardization study project based on standardized NR sidelink evolution (abbreviated as NR SL evo) was approved at the 3GPP RAN #95e plenary meeting in March 2022 (see Non-Patent Document 7). The research objectives of NR SL evo include the following aspect:
1) NR sidelink in unlicensed spectrum, abbreviated as SL-U, is researched and standardized. SL-U includes both resource allocation mode 1 and resource allocation mode 2 for NR sidelink. The research project specifically includes:
   a. In SL-U, channel access technology and operations of NR radio in unlicensed spectrum communication (NR unlicensed, abbreviated as NR-U) are reused. The channel technology of NR-U refers to the Listen Before Talk (abbreviated as LBT) technology, i.e., “listen before talk,” which indicates that before performing transmission, the user equipment needs to monitor a channel resource used for the transmission, and performs the transmission if the channel is idle. Otherwise, the transmission is aborted.
   b. Research is conducted on the design framework of physical channels in sidelink: that is, a necessary modification is made to a structure of a physical channel in existing NR sidelink, to enable SL-U.

At the 3GPP RAN1 #112bis meeting in February 2023, the following meeting conclusions were reached regarding SL-U (see Non-Patent Document 8):
1) For interlace resource block based (interlace RB-based) resource allocation:
   Regarding the mapping relationship between sub-channels and interlace RBs: a sub-channel is defined and numbered in a resource block set (RB set) and is repeatedly numbered in different RB sets in the resource pool.

The solution of the present patent includes a method for a sidelink user equipment to perform resource selection in an interlace RB-based resource allocation mode,
and,
the solution of the present patent also includes a method for a media access control layer (MAC) of a sidelink user equipment to trigger a physical layer to perform resource sensing in an interlace RB-based resource allocation mode.

### PRIOR ART DOCUMENTS

### Non-Patent Documents

Non-Patent Document 1: RP-140518, Work item proposal on LTE Device to Device Proximity Services
Non-Patent Document 2: RP-142311, Work Item Proposal for Enhanced LTE Device to Device Proximity Services
Non-Patent Document 3: RP-152293, New WI proposal: Support for V2V services based on LTE sidelink
Non-Patent Document 4: RP-170798, New WID on 3GPP V2X Phase 2
Non-Patent Document 5: RP-181480, New SID Proposal: Study on NR V2X
Non-Patent Document 6: RP-202846, WID revision: NR sidelink enhancement
Non-Patent Document 7: RP-220300, WID revision: NR sidelink evolution
Non-Patent Document 8: RAN1 #112 Chairman's notes, section 9.4.1.2

### SUMMARY OF THE INVENTION

In order to address at least part of the aforementioned issues, the present invention provides a method performed by a user equipment, and a user equipment.

According to a first aspect of the present invention, provided is a method performed by a user equipment, comprising the following steps:
selecting, by a sidelink user equipment, to generate one selected sidelink grant, the one selected sidelink grant corresponding to transmissions of one or more media access control layer (MAC) protocol data units (PDUs); and
performing, by the user equipment, a transmission resource selection procedure.

In the above-described method performed by a user equipment, optionally,
the resource allocation mode of the user equipment is a sensing-based resource allocation mode, a partial sensing-based resource allocation mode, or a random resource selection-based resource allocation mode.

In the above-described method performed by a user equipment, optionally,
for sidelink unlicensed, the user equipment selects a sidelink time-frequency resource r for one transmission opportunity.

In the above-described method performed by a user equipment, optionally,
the user equipment selects one time-frequency resource from a candidate resource set reported by a physical layer.

In the above-described method performed by a user equipment, optionally,
if the user equipment selects one or more hybrid automatic repeat request (HARQ) retransmissions, and there is still available resources in the candidate resource reported by the physical layer, then the user equipment selects a sidelink time-frequency resource from the available sidelink resources for the one or more transmission opportunities.

In the above-described method performed by a user equipment, optionally,
the numbers of RB sets corresponding, in the frequency domain, to the sidelink time-frequency resource selected for the one or more transmission opportunities and/or the time-frequency resource r are equal; or,
the numbers of sub-channels of the sidelink time-frequency resource selected for the one or more transmission opportunities and/or the time-frequency resource r in one RB set are equal.

The above-described method performed by a user equipment, optionally, further includes the following steps:
in unlicensed spectrum, for the sensing-based resource allocation mode, requesting, by a higher layer, the sidelink user equipment to determine a resource subset for a physical sidelink shared channel (PSSCH)/physical sidelink control channel (PSCCH) transmission; and
determining, by the user equipment, a candidate single-slot resource for the PSSCH/PSCCH transmission.

In the above-described method performed by a user equipment, optionally,
the higher layer provides, in slot n, at least the following parameters for the PSSCH/PSCCH transmission:
the number L_{subCH_RBset} of sub-channels in each RB set for the PSSCH/PSCCH transmission; and
the number N_{RBset} of RB sets for the PSSCH/PSCCH transmission.

In the above-described method performed by a user equipment, optionally,
resource blocks corresponding to the same L_{subCH_RBset} sub-channels in any N_{RBset} RB sets in any slot of the sidelink resource pool within a resource selection window correspond to one candidate single-slot resource.

According to a second aspect of the present invention, provided is a method performed by a user equipment, comprising the following steps:
in unlicensed spectrum, for a sensing-based resource allocation mode, requesting, by a higher layer, a sidelink user equipment to determine a resource subset for a physical sidelink shared channel (PSSCH)/physical sidelink control channel (PSCCH) transmission.

According to a third aspect of the present invention, provided is a user equipment, comprising:
a processor; and
a memory storing instructions,
the instructions, when run by the processor, cause the user equipment to perform the method described above.

### Beneficial Effects of Present Invention

In SL-U, the solution of the present invention describes that, in an interlace RB-based resource allocation mode, all resources selected by the user equipment for the same Transport Block (TB) include an equal number of RB sets, or all resources have an equal number of sub-channels within one RB set. The solution of the present invention ensures that a frequency domain resource assignment indication field in an SCI can effectively indicate reserved resources, thereby effectively reducing signaling overhead in the SCI and improving the reliability of sidelink transmission in unlicensed spectrum.

### BRIEF DESCRIPTION OF THE DRAWINGS

The above and other features of the present invention will be more apparent from the following detailed description in combination with the accompanying drawings, in which:

FIG. 1 is a schematic diagram showing a basic procedure of a method performed by a user equipment according to Embodiment 1 of the present invention.

FIG. 2 is a schematic diagram showing a basic procedure of a method performed by a user equipment according to Embodiment 2 of the present invention.

FIG. 3 is a block diagram showing a user equipment according to an embodiment of the present invention.

### DETAILED DESCRIPTION OF PREFERRED EMBODIMENTS

The following describes the present invention in detail with reference to the accompanying drawings and specific implementations. It should be noted that the present invention should not be limited to the specific implementations described below. In addition, detailed descriptions of well-known technologies not directly related to the present invention are omitted for the sake of brevity, in order to avoid obscuring the understanding of the present invention.

In the following description, a 5G mobile communication system and later evolved versions thereof are used as exemplary application environments to set forth a plurality of embodiments according to the present invention in detail. However, it is to be noted that the present invention is not limited to the following embodiments, but is applicable to many other wireless communication systems, such as a communication system after 5G and a 4G mobile communication system before 5G.

Some terms involved in the present invention are described below. Unless otherwise specified, the terms used in the present invention use the definitions herein. The terms given in the present invention may vary in LTE, LTE-Advanced, LTE-Advanced Pro, NR, and subsequent communication systems, but unified terms are used in the present invention. When applied to a specific system, the terms may be replaced with terms used in the corresponding system.
3GPP: 3rd Generation Partnership Project
LTE: Long Term Evolution
NR: New Radio
PDCCH: Physical Downlink Control Channel
DCI: Downlink Control Information
PDSCH: Physical Downlink Shared Channel
UE: User Equipment
eNB: evolved NodeB, evolved base station
gNB: NR base station
TTI: Transmission Time Interval
OFDM: Orthogonal Frequency Division Multiplexing
CP-OFDM: Cyclic Prefix Orthogonal Frequency Division Multiplexing
C-RNTI: Cell Radio Network Temporary Identifier
CSI: Channel State Information
HARQ: Hybrid Automatic Repeat Request
CSI-RS: Channel State Information Reference Signal
CRS: Cell Reference Signal
PUCCH: Physical Uplink Control Channel
PUSCH: Physical Uplink Shared Channel
UL-SCH: Uplink Shared Channel
CG: Configured Grant
Sidelink: sidelink
SCI: Sidelink Control Information
PSCCH: Physical Sidelink Control Channel
MCS: Modulation and Coding Scheme
RB: Resource Block
RE: Resource Element
CRB: Common Resource Block
CP: Cyclic Prefix
PRB: Physical Resource Block
PSSCH: Physical Sidelink Shared Channel
FDM: Frequency Division Multiplexing
RRC: Radio Resource Control
RSRP: Reference Signal Receiving Power
SRS: Sounding Reference Signal
DMRS: Demodulation Reference Signal
CRC: Cyclic Redundancy Check
PSDCH: Physical Sidelink Discovery Channel
PSBCH: Physical Sidelink Broadcast Channel
SFI: Slot Format Indication
TDD: Time Division Duplexing
FDD: Frequency Division Duplexing
SIB: System Information Block
SIB1: System Information Block Type 1
SLSS: Sidelink Synchronization Signal
PSSS: Primary Sidelink Synchronization Signal
SSSS: Secondary Sidelink Synchronization Signal
PCI: Physical Cell ID
PSS: Primary Synchronization Signal
SSS: Secondary Synchronization Signal
BWP: Bandwidth Part
GNSS: Global Navigation Satellite System
SFN: System Frame Number (radio frame number)
DFN: Direct Frame Number
IE: Information Element
SSB: Synchronization Signal Block
EN-DC: EUTRA-NR Dual Connection, LTE-NR Dual Connectivity
MCG: Master Cell Group
SCG: Secondary Cell Group
PCell: Primary Cell
SCell: Secondary Cell
PSFCH: Physical Sidelink Feedback Channel
SPS: Semi-Persistent Scheduling
TA: Timing Advance
PT-RS: Phase-Tracking Reference Signal
TB: Transport Block
CB: Code Block
QPSK: Quadrature Phase Shift Keying
16/64/256 QAM: 16/64/256 Quadrature Amplitude Modulation
AGC: Automatic Gain Control
TDRA (field): Time Domain Resource Assignment indication (field)
FDRA (field): Frequency Domain Resource Assignment indication (field)
ARFCN: Absolute Radio Frequency Channel Number
SC-FDMA: Single Carrier-Frequency Division Multiple Access
MAC: Medium Access Control
PDU: Protocol Data Unit;
DRX: Discontinuous Reception
SL-U: Sidelink unlicensed, sidelink in unlicensed spectrum
NR-U: NR unlicensed, NR in unlicensed spectrum
LBT: Listen Before Talk
TBS: Transport Block Size
CQI: Channel Quality Information
CPE: Cyclic Prefix extension

The following is a description of the prior art associated with the solution of the present invention. Unless otherwise specified, the same terms in the specific embodiments have the same meanings as in the prior art.

It is worth pointing out that the V2X and sidelink mentioned in the description of the present invention have the same meaning. The V2X herein can also mean sidelink; similarly, the sidelink herein can also mean V2X, and no specific distinction and limitation will be made in the following text.

The resource allocation mode of V2X (sidelink) communication and the transmission mode of V2X (sidelink) communication in the description of the present invention can equivalently replace each other. The resource allocation mode involved in the description can mean a transmission mode, and the transmission mode involved herein can mean a resource allocation mode. In NR sidelink, transmission mode 1 represents a base station scheduling-based transmission mode (resource allocation mode); and transmission mode 2 represents a user equipment sensing-based and resource selection-based transmission mode (resource allocation mode).

The PSCCH in the description of the present invention is used to carry SCI. The PSSCH associated with or relevant to or corresponding to or scheduled by PSCCH involved in the description of the present invention has the same meaning, and all refer to an associated PSSCH or a corresponding PSSCH. Similarly, the SCI (including first stage SCI and second stage SCI) associated with or related to or corresponding to PSSCH involved in the description has the same meaning, and all refer to associated SCI or corresponding SCI. It is worth pointing out that the first stage SCI, referred to as 1st stage SCI or SCI format 1-A, is transmitted in the PSCCH, and the second stage SCI, referred to as 2^{nd} stage SCI or SCI format 2-A (or SCI format 2-B), is transmitted on a resource of the corresponding PSSCH.

In the description of the present invention, NR sidelink performed in unlicensed spectrum (abbreviated as SL-U) may also be referred to as shared spectrum channel access, that is, in unlicensed spectrum, there may exist a user equipment that accesses a channel using the Wifi technology (a wireless local area network technology based on an IEEE 802.11 standard), as well as an NR sidelink user equipment accessing via a PC5 interface.

### Numerologies in NR (Including NR Sidelink) and Slots in NR (Including NR Sidelink)

A numerology includes two aspects: a subcarrier spacing and a cyclic prefix (CP) length. NR supports five subcarrier spacings, which are respectively 15 kHz, 30 kHz, 60 kHz, 120 kHz, and 240 kHz (corresponding to μ=0, 1, 2, 3, 4). Table 4.2-1 shows the supported transmission numerologies, specifically as follows.

TABLE 4.2-1
Subcarrier Spacings Supported by NR

| μ | Δƒ = 2^{μ} · 15 [KHz] | CP (cyclic prefix) |
|---|---|---|
| 0 | 15 | Normal |
| 1 | 30 | Normal |
| 2 | 60 | Normal, extended |
| 3 | 120 | Normal |
| 4 | 240 | Normal |

Only when μ=2, namely, in the case of a 60-kHz subcarrier spacing, is the extended CP supported, and only the normal CP is supported in the case of other subcarrier spacings. For the normal CP, each slot includes 14 OFDM symbols; for the extended CP, each slot includes 12 OFDM symbols. For μ=0, namely, a 15 kHz subcarrier spacing, one slot=1 ms; for μ=1, namely, a 30 kHz subcarrier spacing, one slot=0.5 ms; for μ=2, namely, a 60 kHz subcarrier spacing, one slot=0.25 ms, and so on.

NR and LTE have the same definition for a subframe, which denotes 1 ms. For a subcarrier spacing configuration μ, a slot index in one subframe (1 ms) may be expressed as

$${n}_{s}^{μ} ,$$

and ranges from 0 to

$${N}_{slot}^{subframe , μ} - 1.$$

A slot index in one system frame (a duration of 10 ms) may be expressed as

$${n}_{s , f}^{μ} ,$$

and ranges from 0 to

$${N}_{slot}^{frame , μ} - 1.$$

### Definitions of

$${N}_{slot}^{subframe , μ} and$$

for different subcarrier spacings u are shown in the tables below.

TABLE 4.3.2-1
the number of symbols included in each slot, the number of slots
included in each system frame, and the number of slots included
in each subframe for the normal CP

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 4.3.2-2
the number of symbols included in each slot, the number of slots
included in each system frame, and the number of slots included in
each subframe for the extended CP (60 kHz)

| μ | ${N}_{symb}^{slot}$ | ${N}_{slot}^{frame , μ}$ | ${N}_{slot}^{subframe , μ}$ |
|---|---|---|---|
| 2 | 12 | 40 | 4 |

On an NR carrier, a system frame (or simply referred to as frame) number (SFN) ranges from 0 to 1023. The concept of a direct system frame number (DFN) is introduced to sidelink, and the number thereof likewise ranges from 0 to 1023. The above description of the relationship between the system frame and numerology can also be applied to a direct system frame. For example, the duration of one direct system frame is likewise equal to 10 ms; for a 15 kHz subcarrier spacing, one direct system frame includes 10 slots, and so on. The DFN is applied to timing on a sidelink carrier.

### Resource Block (RB) and Resource Element (RE)

The resource block (RB) is defined in the frequency domain as N_{sc}^{RB}=12 consecutive subcarriers. For example, for a 15 kHz subcarrier spacing, the RB is 180 kHz in the frequency domain. For a 15 kHz×2^{μ} subcarrier spacing, the resource element (RE) represents one subcarrier in the frequency domain and one OFDM symbol in the time domain.

### Sidelink Communication Scenario

1) Out-of-coverage sidelink: both of two UEs performing sidelink are out of coverage (for example, the UE cannot detect any cell that meets a “cell selection criterion” on a frequency at which sidelink needs to be performed, meaning the UE is out of coverage).
2) In-coverage sidelink: both of two UEs performing sidelink are in coverage (for example, the UE detects at least one cell that meets a “cell selection criterion” on a frequency at which sidelink needs to be performed, meaning the UE is in coverage).
3) Partial-coverage sidelink: one of two UEs performing sidelink communication is out of network coverage, and the other is in network coverage.

From the perspective of the UE side, the UE only has two scenarios, out-of-coverage and in-coverage. Partial-coverage is described from the perspective of sidelink communication.

### Sidelink Resource Pool

In sidelink, resources transmitted and received by UE all belong to resource pools. For example, for a base station scheduling-based transmission mode in sidelink, the base station schedules transmission resources for sidelink UE in a resource pool; alternatively, for a UE sensing-based transmission mode in sidelink, the UE determines a transmission resource in a resource pool.

For NR sidelink, resource allocation based on sub-channels as the minimum granularity is supported in the frequency domain. that is, for a PSSCH transmission, the resources occupied in the frequency domain are an integer number of sub-channels. One sub-channel may represent several consecutive RBs in the frequency domain.

### Sensing-Based Resource Allocation Mode

For a sensing-based resource allocation mode (resource allocation mode 2), a sidelink user equipment selects a candidate resource within one time window (optionally, a resource selection window [n+T1, n+T2]), determines, according to a reserved resource indicated by a PSCCH transmitted by another user equipment in a monitoring slot, candidate resources overlapping with the reserved resource, and excludes the foregoing candidate resources overlapping with the reserved resource. The physical layer reports, to the MAC layer, a set of candidate resources that are not excluded, and the MAC layer selects transmission resources for the PSSCH/PSCCH. The set of the transmission resources selected by the MAC layer is referred to as a selected sidelink grant. Sidelink resources included in one selected sidelink grant may be used for the first transmission and all retransmissions of one MAC PDU (corresponding to one transport block (TB)), or may be used for the first transmission and all retransmissions of a plurality of MAC PDUs (corresponding to a plurality of transport blocks (TBs)). The present invention does not impose any limitation on the foregoing.

Resource Selection Window [n+T1, n+T2]

In a resource allocation mode based on sensing (or, partial sensing), a higher layer requests or triggers, in a slot n, the physical layer to determine a resource for PSSCH/PSCCH transmission (to perform sensing or partial sensing). The resource selection window is defined as [n+T1, n+T2]. That is, user equipment selects a transmission resource within the foregoing window. T1 satisfies the condition

$$0 \leq T 1 \leq {T}_{proc , 1}^{SL} ,$$

and the selection of T1 is up to user equipment implementation. RRC configuration information includes a resource selection window configuration list sl-Selection WindowList, and an element on the list and corresponding to a given priority prio_{TX} (the priority of transmitting the PSSCH) is represented by T₂ₘᵢₙ. If T₂ₘᵢₙ is less than a remaining packet delay budget (abbreviated as remaining PDB), T2 satisfies the condition T₂ₘᵢₙ≤T2≤remaining PDB, and the selection of T2 is up to user equipment implementation; otherwise, T2 is set to the remaining PDB.

$${T}_{proc , 1}^{SL}$$

is defined as shown in the table below (μ_{SL} represents a sidelink subcarrier spacing parameter, that is, the subcarrier spacing is 2^{μ}^{_{SL}}×15 kHz):

TABLE 8.1.4-2
$Values for {T}_{proc , 1}^{SL}$

| μ_{SL} | ${T}_{proc , 1}^{SL} [ slots ]$ |
|---|---|
| 0 | 3 |
| 1 | 5 |
| 2 | 9 |
| 3 | 17 |

TABLE 8.1.4-1
$Values for {T}_{proc , 0}^{SL}$

| μ_{SL} | ${T}_{proc , 0}^{SL} [ slots ]$ |
|---|---|
| 0 | 1 |
| 1 | 1 |
| 2 | 2 |
| 3 | 4 |

### LBT (Listen Before Talk) Mechanism

For wireless communication in unlicensed spectrum, some countries or regions (for example, European regions) stipulate that, before performing wireless communication transmission, a user equipment needs to perform an LBT operation i.e., a “Listen Before Talk” mechanism, which can also be referred to as a channel access operation, representing a mechanism for determining channel availability by sensing channels. Specifically, in a period of time before communication transmission, the user equipment performs transmission only when monitoring that the channel is idle; otherwise, the user equipment does not perform transmission.

Specifically, for NR communication in unlicensed spectrum (NR-U) (or, for SL-U), the basic time unit for sensing the channel may be Tₛₗ=9 μs. During the time unit, if a duration in which energy detected by the base station or the user equipment on the channel is less than an energy threshold X_{Thresh} is equal to or exceeds 4 μs, the base station or the user equipment considers that the channel is idle during the time unit (or referred to as LBT being successful). It is worth pointing out that the channel on which the base station or user equipment detects energy and uses same to determine whether the channel is idle represents a carrier including a consecutive RB set or a portion of that carrier. The channel may also be referred to as an LBT bandwidth, an LBT sub-band, or an RB set. One LBT bandwidth or RB set may be equal to 20 MHz in the frequency domain, that is, one RB set may exist on a carrier of 20 MHz. The number of RBs corresponding to a plurality of RB sets included on one carrier (a carrier exceeding 20 MHz, for example, 40 MHz, 60 MHz, or 80 MHz) and a guard band (GB for short) between two consecutive RB sets may be as shown in the table below:

TABLE 1
the number of RBs included in all RB sets and GBs on one
carrier for 15 kHz and 30 kHz subcarrier spacings

| SCS | | | |
|---|---|---|---|
| (kHz) | 40 MHz | 60 MHz | 80 MHz |
| 15 | 105-6-105 | N/A | N/A |
| | (216) | | |
| 30 | 50-6-50 | 50-6-50-6-50 | 50-6-50-5-50-6-50 |
| | (106) | (162) | (217) |

In the foregoing table, taking a subcarrier spacing of 15 kHz and a carrier bandwidth of 40 MHz for example, 105-6-105 indicates that the carrier includes two consecutive RB sets, each including 105 RBs. Between the two RB sets, there is a guard band (GB) including 6 consecutive RBs, totaling 216 consecutive RBs. Similar inference may be made for the other items in Table 1.

It is worth pointing out that the LBT operations performed by the (sidelink) user equipment on the different RB sets may be independent of each other (that is, there is no correlation between the RB sets). For example, the user equipment detects that the channel is idle on the RB set 1, and detects that the channel may be occupied (or busy) on the RB set 2. If the resources selected by the sidelink user equipment for a PSSCH/PSCCH transmission include (all or part of) the RBs corresponding to both the RB set 1 and the RB set 2, and if and only if the user equipment detects that the channel is idle on the RB set 1 and the RB set 2 at the same time, the user equipment may transmit the corresponding PSSCH/PSCCH.

### Interlace RB-Based Resource Allocation Mode

For sidelink unlicensed, on the basis of support for a consecutive RB-based resource allocation mode, an interlace RB-based resource allocation mode is also supported. For interlace RB-based resource allocation, one sub-channel may correspond to RBs in different RB sets. Specifically: a sub-channel is defined and numbered in a RB set and is repeatedly numbered in different RB sets in the resource pool. For example, RB set #0 includes 10 sub-channels, which are sub-channel #0 to sub-channel #9 respectively, and RB set #1 also includes 10 sub-channels, and so on.

In SL-U, when the frequency domain resource allocation is indicated in the SCI, in addition to a starting sub-channel and the number of occupied sub-channels, information of the RB set occupied by the PSSCH/PSCCH transmission also needs to be indicated. For example, if one PSSCH/PSCCH transmission occupies two sub-channels in the frequency domain, the sub-channels used for the transmission may be sub-channel #0 and sub-channel #1 in RB set #0, or may be sub-channels #0 in RB set #0 and RB set #1.

Hereinafter, specific examples and embodiments related to the present invention are described in detail. In addition, as described above, the examples and embodiments described in the present disclosure are illustrative descriptions for facilitating understanding of the present invention, rather than limiting the present invention.

### Embodiment 1

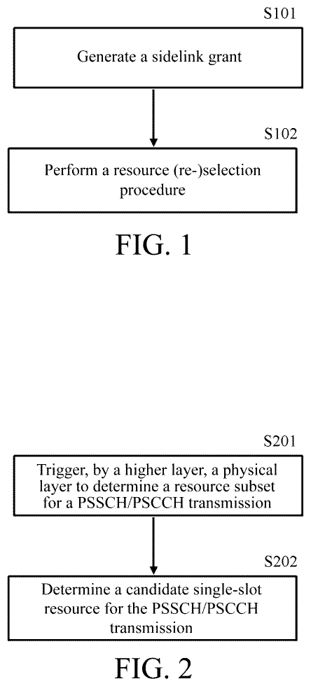

FIG. 1 is a schematic diagram showing a basic procedure of a method performed by a user equipment according to Embodiment 1 of the present invention.

The method performed by a user equipment according to Embodiment 1 of the present invention is described in detail below in conjunction with the basic procedure diagram shown in FIG. 1.

As shown in FIG. 1, in Embodiment 1 of the present invention, the steps performed by the user equipment include the following:

In step S101, a sidelink user equipment selects to generate one selected sidelink grant, and optionally, in a logical channel, sidelink data is available.

Optionally, the one selected sidelink grant corresponds to transmissions of one or more MAC PDUs.

In step S102, the user equipment performs a transmission resource (re-)selection procedure.

Optionally, if a result of a resource (re-)selection check is to trigger resource (re-)selection, the user equipment performs the transmission resource (re-)selection procedure.

Optionally, the resource allocation mode of the user equipment is a sensing-based resource allocation mode, a partial sensing-based resource allocation mode, or a random resource selection-based resource allocation mode.

Optionally, for shared spectrum channel access (or for the sidelink unlicensed),
the user equipment (randomly) selects a sidelink time-frequency resource r for one transmission opportunity, where optionally, the user equipment (randomly) selects one time-frequency resource from a candidate resource set reported (or indicated) by a physical layer;
and/or
if the user equipment selects one or more HARQ retransmissions, and there is still available resources in the candidate resource reported (or indicated) by the physical layer, then
the user equipment (randomly) selects a sidelink time-frequency resource from the available sidelink resources for the one or more transmission opportunities (for HARQ retransmission), where optionally, the numbers of RB sets corresponding, in the frequency domain, to the sidelink time-frequency resource selected for the one or more transmission opportunities and/or the time-frequency resource r are equal, or the numbers of sub-channels of the sidelink time-frequency resource selected for the one or more transmission opportunities and/or the time-frequency resource r in one (or any one, or each) RB set are equal.

### Embodiment 2

FIG. 2 is a schematic diagram showing a basic procedure of a method performed by a user equipment according to Embodiment 2 of the present invention.

The method performed by a user equipment according to Embodiment 2 of the present invention is described in detail below in conjunction with the basic procedure diagram shown in FIG. 2.

As shown in FIG. 2, in Embodiment 2 of the present invention, steps performed by the user equipment include:

In step S201, in unlicensed spectrum (or shared spectrum), for resource allocation mode 2, a higher layer (or an upper layer) requests (or triggers) a sidelink user equipment (a physical layer) to determine a resource subset for a PSSCH/PSCCH transmission.

Optionally, the higher layer provides, in slot n, at least the following parameters for the PSSCH/PSCCH transmission:
a number L_{subCH_RBset} of sub-channels in each RB set for the PSSCH/PSCCH transmission; and
a number N_{RBset} of RB sets for the PSSCH/PSCCH transmission.

In step S202, the user equipment determines a candidate single-slot resource for the PSSCH/PSCCH transmission.

Optionally, the user equipment assumes that RBs corresponding to the same L_{subCH_RBset} (consecutive or non-consecutive) sub-channels in any N_{RBset} (consecutive or non-consecutive) RB sets in any slot of the sidelink resource pool within the resource selection window [n+T1, n+T2] correspond to one candidate single-slot resource.

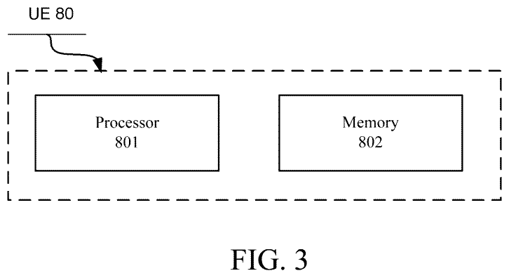

FIG. 3 is a block diagram showing a user equipment (UE) to which the present invention relates. As shown in FIG. 3, the user equipment (UE) 80 includes a processor 801 and a memory 802. The processor 801 may include, for example, a microprocessor, a microcontroller, or an embedded processor. The memory 802 may, for example, include a volatile memory (e.g., a random access memory (RAM)), a hard disk drive (HDD), a non-volatile memory (e.g., a flash memory), or other memories. The memory 802 has program instructions stored thereon. The instructions, when run by the processor 801, can perform the method performed by a user equipment described in detail in the present invention.

The method and related equipment according to the present invention have been described above in combination with preferred embodiments. It should be understood by those skilled in the art that the method shown above is only exemplary, and the above-described embodiments can be combined with one another as long as no contradiction arises. The method of the present invention is not limited to the steps or sequences illustrated above. The network node and user equipment illustrated above may include more modules. For example, the network node and user equipment may further include modules that can be developed or will be developed in the future to be applied to a base station, an MME, or UE, and the like. Various identifiers illustrated above are only exemplary, and are not meant to be limiting. The present invention is not limited to specific information elements serving as examples of these identifiers. Those skilled in the art could make various alterations and modifications according to the teachings of the illustrated embodiments.

It should be understood that the above-described embodiments of the present invention may be implemented by software, hardware, or a combination of software and hardware. For example, various components in the base station and user equipment in the above embodiments can be implemented by multiple devices, and these devices include, but are not limited to: an analog circuit device, a digital circuit device, a digital signal processing (DSP) circuit, a programmable processor, an application-specific integrated circuit (ASIC), a field-programmable gate array (FPGA), a complex programmable logic device (CPLD), and the like.

In the present application, the term “base station” may refer to a mobile communication data and control exchange center having large transmission power and a wide coverage area, including functions such as resource allocation and scheduling and data reception and transmission. The term “user equipment” may refer to user mobile terminals, such as terminal devices that can wirelessly communicate with a base station or a micro base station, including a mobile phone, a laptop computer, and the like.

In addition, the embodiments of the present invention disclosed herein may be implemented on a computer program product. More specifically, the computer program product is a product provided with a computer-readable medium having computer program logic encoded thereon. When executed on a computing device, the computer program logic provides related operations to implement the above technical solutions of the present invention. When executed on at least one processor of a computing system, the computer program logic enables the processor to execute the operations (methods) described in the embodiments of the present invention. Such an arrangement of the present invention is typically provided as software, code, and/or other data structures that are configured or encoded on a computer-readable medium, such as an optical medium (e.g., a CD-ROM), a floppy disk or a hard disk, or, for example, firmware or other media of microcodes on one or more ROM or RAM or PROM chips, or downloadable software images, shared database and so on in one or more modules. Software or firmware or such configuration may be installed on a computing device such that one or more processors in the computing device performs the technical solutions described in the embodiments of the present invention.

In addition, each functional module or each feature of the base station device and the terminal device used in each of the above embodiments may be implemented or executed by circuits, which are usually one or more integrated circuits. Circuits designed to execute various functions described in this description may include general-purpose processors, digital signal processors (DSPs), application specific integrated circuits (ASICs) or general-purpose integrated circuits, field programmable gate arrays (FPGAs) or other programmable logic devices, discrete gates or transistor logic, or discrete hardware components, or any combination of the above. The general-purpose processor may be a microprocessor, or the processor may be an existing processor, a controller, a microcontroller, or a state machine. The aforementioned general-purpose processor or each circuit may be configured by a digital circuit or may be configured by a logic circuit. Furthermore, when advanced technology capable of replacing current integrated circuits emerges due to advances in semiconductor technology, the present invention can also use integrated circuits obtained using this advanced technology.

While the present invention has been illustrated in combination with the preferred embodiments of the present invention, it will be understood by those skilled in the art that various modifications, substitutions, and alterations may be made to the present invention without departing from the spirit and scope of the present invention. Therefore, the present invention should not be limited by the above-described embodiments, but should be defined by the appended claims and their equivalents.

1-3. (canceled)

4. A user equipment, comprising:
a processor configured to:
determine a subset of sidelink (SL) resources based on a number L_{subCH_RBset} of sub-channel(s) in each resource block set(s) for a physical sidelink shared channel (PSSCH)/physical sidelink control channel (PSCCH) and a number N_{RBset} of resource block sets for the PSSCH/PSCCH transmission, the number L_{subCH_RBset} and the number N_{RBset} being provided by a higher layer; and
select a resource(s) for the PSSCH/PSCCH transmission from the subset of SL resources.

5. A method performed by a user equipment, the method comprising:
determining a subset of sidelink (SL) resources based on a number L_{subCH_RBset} of sub-channel(s) in each resource block set(s) for a physical sidelink shared channel (PSSCH)/physical sidelink control channel (PSCCH) and a number N_{RBset} of resource block sets for the PSSCH/PSCCH transmission, the number L_{subCH_RBset} and the number N_{RBset} being provided by a higher layer; and
selecting a resource(s) for the PSSCH/PSCCH transmission from the subset of SL resources.
